(19) United States
(12) Patent Application Publication
(10) Pub. No.: US 2005/0147868 A1
(43) Pub. Date: Jul. 7, 2005

(54) Fuel cell

(75) Inventors: Akihiko Takeda, Tsukui-gun (JP); Takato Chiba, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/987,865

(22) Filed: Nov. 12, 2004

(30) Foreign Application Priority Data
Nov. 19, 2003 (JP) JP2003-388915

(51) Int. Cl. H01M 4/86; H01M 8/10; H01M 4/96; H01M 4/92

(52) U.S. Cl. 429/42; 429/30; 429/44

(57) ABSTRACT

A fuel cell comprising: (a) a solid polymer electrolyte film; (b) an anode layer, one surface of which contacting one surface of the solid polymer electrolyte film, and fuel being supplied to the other surface of the anode layer; and (c) a cathode layer, one surface of which contacting the other surface of the solid polymer electrolyte film and an oxidizing gas being supplied to the other surface of the cathode layer, wherein at least one of the anode layer and the cathode layer contains a water repellent agent and an ionic conductor, wherein the concentration of the water repellent agent decreases from the surface to which fuel is supplied to the surface contacting the electrolyte film in the anode, and decreases from the surface contacting the electrolyte to the surface to which an oxidizing gas is supplied in the cathode.

### TECHNICAL FIELD

The present invention relates to a fuel cell containing a polymer solid electrolyte and in more detail, relates to a fuel cell preferably used for a direct methanol fuel cell.

### BACKGROUND

A direct methanol fuel cell has attracted attention as a candidate for distributed resources of power supply or a portable power supply, since, in this fuel cell, liquid methanol is directly utilized for power generation without taking out hydrogen by reforming liquid methanol, and a small size and light weight power supply is easily obtained due to the simple power generation structure.

A direct methanol fuel cell contains: (i) a proton conducting solid electrolyte film; (ii) an anode layer and a cathode layer provided on both surfaces of the proton conducting solid electrolyte film, in which each of the anode and the cathode layers are produced by applying a catalyst on a porous carbon paper which works as a diffusion layer; (iii) an anode side separator having grooves to supply an aqueous solution of methanol as a fuel; and (iv) a cathode side separator having grooves to supply air as a oxidizing gas. When an aqueous solution of methanol is supplied to the anode and air is supplied to the cathode, carbon dioxide gas is formed at the anode, together with generation of hydrogen ions and electrons at the anode (CH₃OH+H₂O→CO₂+6H⁺+6e⁻), and the hydrogen ions passing through the electrolyte react with the air to form water due to a reduction reaction (6H⁺+(3/2)O₂+6e⁻→3H₂O, while, electric energy is obtained through the outer circuit connecting the anode and the cathode. Namely, the overall reaction of a direct methanol fuel cell is a reaction of methanol and oxygen to form water and carbon dioxide.

Behavior of the above mentioned direct methanol fuel cell is largely influenced by properties of the electrodes. Since each of the oxidizing reactions at the anode and the reduction reaction at the cathode proceeds at an interface of a catalyst and the electrolyte, supply of methanol and oxygen into the inside of the cell and removal of produced water and carbon dioxide from the inside of the cell are important factors to control reaction efficiency and power of a direct methanol fuel cell.

Electrode structures of direct methanol fuel cells produced so far have not been fully successful to promote transfer of reactants and products of the cell reaction and higher energy efficiency of a fuel cell has been relatively difficult to achieve. On the other hand, it is also possible to use a method to promote transfer of reactants and products of the cell reaction using a pump or a blower, however, this kind of auxiliary method consumes a part of the generated electric energy, resulting in a loss of energy. The loss ratio is greater when the cell system is smaller.

In order to evenly spread out reaction gas into the inside of a cell, proposed in Patent Document 1 is an electrode having pores which are uniformly distributed in the plane direction and have a gradient in pore size in the thickness direction.

(Patent Document 1)
Japanese Patent Publication Open to Public Inspection (hereafter referred to as JP-A) No. 10-158830

The technique described in the above patent document is oriented to control the flow of hydrogen fuel gas but is not fully effective to promote transfer of produced water and supplied methanol in a direct methanol fuel cell.

As has been described so far, promotion of effectiveness of the reaction and improvement in power may be achieved by promoting transfer of reactants and products in the fuel cell. Accordingly, desired functions for a fuel cell are: (i) lower diffusion resistance of fuel; (ii) higher electrical conductivity; and (iii) a preferable balance between hydrophilic and hydrophobic properties.

### SUMMARY OF THE INVENTION

An object of the present invention is to provide a direct methanol fuel cell which enables highly efficient transfer of gas and fluid, or highly efficient transfer of reactants and products in the fuel cell and enables generation of high power.

One embodiment of the present invention is a fuel cell including: (a) a solid polymer electrolyte film; (b) an anode layer, one surface of which contacting one surface of the solid polymer electrolyte film, and fuel being supplied to the other surface of the anode layer; and (c) a cathode layer, one surface of which contacting the other surface of the solid polymer electrolyte film and an oxidizing gas being supplied to the other surface of the cathode layer, wherein one of the anode layer and the cathode layer containing a water repellent agent and an ionic conductor, wherein a concentration of the water repellent agent in the anode layer or the cathode layer satisfy a predetermined condition.

### DESCRIPTION OF THE PREFERRED EMBODIMENTS

The object of the present invention is achieved by the following structures:
(1) A fuel cell comprising:
   (a) a solid polymer electrolyte film;
   (b) an anode layer, one surface of which contacting one surface of the solid polymer electrolyte film, and fuel being supplied to the other surface of the anode layer; and
   (c) a cathode layer, one surface of which contacting the other surface of the solid polymer electrolyte film and an oxidizing gas being supplied to the other surface of the cathode layer,
   wherein at least one of the anode layer and the cathode layer contains a water repellent agent and an ionic conductor,
      wherein:
      (i) a concentration of the water repellent agent in the anode layer decreases from the surface, to which the fuel is supplied, to the surface contacting the electrolyte film, when the anode layer contains the water repellent agent; and
      (ii) a concentration of the water repellent agent in the cathode layer decreases from the surface contacting the electrolyte to the surface to which the oxidizing gas is supplied, when the cathode layer contains the water repellent agent.
(2) A fuel cell comprising:
   (a) a solid polymer electrolyte film;
   (b) an anode layer, one surface of which contacting one surface of the solid polymer electrolyte film, and fuel being supplied to the other surface of the anode layer; and
   (c) a cathode layer, one surface of which contacting the other surface of the solid polymer electrolyte film and an oxidizing gas being supplied to the other surface of the cathode layer,
   wherein at least one of the anode layer and the cathode layer contains carbon particles having a hydrophilic surface and carbon particles having a hydrophobic surface, each of the carbon particles being loaded with a precious metal catalyst,
      wherein:
      (i) a weight ratio of the carbon particles having the hydrophobic surface to the total weight of the carbon particles in the anode layer decreases from the surface to which fuel is supplied to the surface contacting the electrolyte film, when the anode layer contains the carbon particles having the hydrophilic surface and the carbon particles having the hydrophobic surface; and
      (ii) a weight ratio of the carbon particles having the hydrophobic surface to the total weight of the carbon particles in the cathode layer decreases from the surface contacting the electrolyte film to the surface to which an oxidizing gas is supplied, when the cathode layer contains the carbon particles having the hydrophilic surface and the carbon particles having the hydrophobic surface.
(3) A fuel cell comprising:
   (a) a solid polymer electrolyte film;
   (b) an anode layer, one surface of which contacting one surface of the solid polymer electrolyte film, and fuel being supplied to the other surface of the anode layer; and
   (c) a cathode layer, one surface of which contacting the other surface of the solid polymer electrolyte film and an oxidizing gas being supplied to the other surface of the cathode layer,
   wherein at least one of the anode layer and the cathode layer contains a water repellent agent, an ionic conductor, carbon particles having a hydrophilic surface and carbon particles having a hydrophobic surface, each of the carbon particles being loaded with a precious metal catalyst is loaded,
      wherein:
      (i) a concentration of the water repellent agent and a weight ratio of the carbon particles having the hydrophobic surface to the total weight of the carbon particles in the anode layer decrease from the surface to which the fuel is supplied to the surface contacting the electrolyte film when the anode layer contains the water repellent agent, the carbon particles having the hydrophilic surface and the carbon particles having the hydrophobic surface; and
      (ii) a concentration of the water repellent agent and a weight ratio of the carbon particles having the hydrophobic surface to total carbon particles in the cathode layer decrease from the surface contacting the electrolyte film to the surface to which the oxidizing gas is supplied when the cathode layer contains the water repellent agent, the carbon particles having the hydrophilic surface and the carbon particles having the hydrophobic surface.
(4) The fuel cell of Item 2 or Item 3, wherein the hydrophilic carbon particles are carboxylic carbon particles or sulfonated carbon particles.
(5) The fuel cell of any one of Items 2 to 4, wherein the carbon particles are selected from the group consisting of activated carbon particles, carbon black particles, graphite particles and mixed particles thereof.
(6) The fuel cell of any one of Items 2 to 5, wherein the precious metal catalyst is a platinum catalyst or a platinum alloy catalyst.
(7) The fuel cell of any one of Items 1 to 6, wherein the fuel cell is a direct methanol fuel cell.

In the present invention, it is assumed that the driving force of mass transfer in a fuel cell is largely owed to hydrophilic or hydrophobic properties of component materials of the fuel cell. Based on this assumption, hydrophilic materials and hydrophobic materials having a concentration gradient in the thickness direction are contained in the cell. By using this structure in a direct methanol fuel cell, transfer of water and methanol, or removal of carbon dioxide is promoted.

The present invention is characterized by a fuel cell containing: (a) a solid polymer electrolyte film; (b) an anode layer, one surface of which contacting one surface of the solid polymer electrolyte film, and fuel being supplied to the other surface of the anode layer; and (c) a cathode layer, one surface of which contacting the other surface of the solid polymer electrolyte film and an oxidizing gas being supplied to the other surface of the cathode layer, wherein at least one of the anode layer and the cathode layer contains a water repellent agent, an ionic conductor, carbon particles having a hydrophilic surface and carbon particles having a hydrophobic surface, each of the carbon particles being loaded with a precious metal catalyst, wherein: (i) a concentration of the water repellent agent and a weight ratio of the carbon particles having the hydrophobic surface to the total weight of the carbon particles in the anode layer decrease from the surface to which the fuel is supplied to the surface contacting the electrolyte film when the anode layer contains the water repellent agent, the carbon particles having the hydrophobic surface and the carbon particles having the hydrophilic surface; and ii) a concentration of the water repellent agent and a weight ratio of the carbon particles having the hydrophobic surface to total carbon particles in the cathode layer decrease from the surface contacting the electrolyte film to the surface to which the oxidizing gas is supplied when the cathode layer contains the water repellent agent, the carbon particles having the hydrophobic surface and the carbon particles having the hydrophilic surface.

Examples of a fuel material which may be used in a the fuel cell of the present invention include: a hydrogen gas, methanol, ethanol, 1-propanol, dimethyl ether and ammonia, of these, methanol is preferable.

Examples of a solid polymer electrolyte film having proton conduction include compounds known in the prior art, for example: a sulfonated polyimide-based polymer electrolyte film, a fluorine-based polymer electrolyte film, a hydrocarbon-based polymer electrolyte film, and an electrolyte film of composite materials thereof.

Examples of a hydrocarbon-based polymer electrolyte material include: (i) sulfonated engineering plastic-based electrolytes, for example, sulfonated polyether ketone, sulfonated polyethersulfone, sulfonated polyether ether sulfone, sulfonated polysulfone, sulfonated polysulfide, and sulfonated polyphenylene; and (ii) sulfoalkylated engineering plastic-based electrolytes, for example, sulfoalkylated polyether ether ketone, sulfoalkylated polyethersulfone, sulfoalkylated polyether ether sulfone, sulfoalkylated polysulfone, sulfoalkylated polysulfide, and sulfoalkylation polyphenylene. The equivalent of sulfonic acid of these electrolyte materials is preferably 0.5 to 2.0 mEq/g dried-resin, and more preferably 0.7 to 1.6 mEq/g dried-resin. When the equivalent of sulfonic acid is less than 0.5 mEq/g dried-resin, the ionic conduction becomes smaller and when the equivalent of sulfonic acid is more than 2.0 mEq/g dried-resin, the electrolyte become more easily to be dissolved in water.

Examples of a water repellent agent used in the present invention include fluorine-containing resins, for example, polytetrafluoroethylene (PTFE) such as Tefron®, a tetrafluoroethylene-perfluoroalkylvinylether copolymer, and a tetrafluoroethylene-hexafluoropropylene copolymer.

An ionic conductor used in the present invention is not specifically limited provided that the ionic conductor is a normally used electrolyte having ionic conduction. For example, a fluorine-base electrolyte, a partially fluorinated electrolyte or a hydrocarbon-based electrolyte may be used.

As fluorine-based electrolyte materials, well known polymer materials are widely adopted. Examples of fluorine-based electrolyte materials include copolymers of:
(i) fluoro-vinyl compounds represented by the formula:
   CF₂═CF—(OCF₂CFX)m-Oq-(CF₂)n-A
   wherein m=0-3, n=0-12, q=0 or 1, X is F or CF3, and A is sulfonic acid-based functional group; and
(ii) perfluoro-olefin, for example, tetrafuluoroethylene, hexafluoropropylene, chlorotrifluoroethylene, and perfluoroalkylvinylether.

Examples of a preferable fluorovinyl compounds include: CF₂═CFO(CF₂)aSO₂F, CF₂═CFOCF₂CF(CF₃)O(CF₂)aSO₂F, CF₂═CF(CF₂)bSO₂F, CF₂═CF(OCF₂CF(CF₃))cO(CF₂)₂SO₂F, wherein a, b and c are integers in the ranges of a=1-8, b=0-8, and c=1-5.

As carbon particles, active carbon, carbon black, graphite, and a mixture of thereof are preferably employed.

Examples of carbon black include, acetylene black, Ketjen Black, furnace black, lamp black, thermal black. Commercially available materials, for example, Denka BLACK (produced by a DENKIKAGAKU-KOGYO-KABUSHIKI-KAISHA), Vulcan XC-72 (produced by Cabot Corp.), Black Pearl 2000 (produced by Cabot Corp.), and Ketjen Black EC 300J (produced by Ketjen Black International Co., Ltd.) may be adopted.

As carbon particles having hydrophilic surfaces, carboxylated carbon particles using carboxyl compounds and sulfonated carbon particles using sulfone compounds are preferable.

As precious metal catalyst, platinum, ruthenium, rhodium, palladium, iridium, gold, silver, iron, cobalt, nickel, chromium, tungsten, manganese, vanadium and alloys of plural metal elements thereof may be used. At least one component of the alloy of plural metal elements is preferably a platinum or a platinum alloy.

Carbon particles loaded with a precious metal catalyst are obtained by: (i) adding a platinum salt or a ruthenium salt to a solution dispersed with carbon black particles, and (ii) hydrazine, for example, is added to the dispersed solution to reduce the salt, followed by filtering and drying. Further, a heat treatment may be conducted. Vulcan XC-72 (Cabot Corp.) loaded with a platinum or a platinum-ruthenium catalyst, commercially available from Tanaka Kikinzoku Group Corp. is also usable.

As described above, the fuel cell of the present invention has a concentration gradient, namely, the concentration of the water repellent agent and the hydrophobically-treated carbon particles carrying a precious metal catalyst decrease from the surface to which fuel is supplied to the surface contacting the electrolyte film in the anode, and decreases from the surface contacting the electrolyte film to the surface to which an oxidizing gas is supplied in the cathode. Preparation of this kind of electrode is possible using a technique known in the prior art, for example, by adjusting concentration of materials in the preparation process of an anode or a cathode, or arranging the amount of material such as a binder in a preparation process of a porous electrode. Specific example of the preparation of these electrode will be described in Example section.

An electrode layer may be formed on an electrolyte film in the following manner, for example: (i) mixing carbon particles loaded with platinum catalyst powder with a solution in which polytetrafluoroethylene powder is dispersed; (ii) applying the mixed solution onto a carbon paper; (iii) forming a catalyst layer by heat treating the carbon paper; (iv) applying a solution containing the same electrolyte material as the electrolyte film onto thus formed catalyst layer; and (v) coupling the two films, followed by hot pressing to form a monolithic film. Alternatively, the following methods may also be applicable: (a) a method to preliminary apply a solution containing the same component as the electrolyte film onto the surface of platinum catalyst powder; (b) a method to apply a catalyst paste onto a electrolyte film; (c) a method to provide electroless plating of an electrode onto an electrolyte film; and (d) a method to prepare an electrolyte film adsorbed with metal complex ions of platinum-group elements, followed by reducing the complex ions. However, the present invention is not limited thereto.

On outer surfaces of the monolithic film containing two electrodes and an electrolyte prepared as described above, a fuel supplying plate (separator) on which fuel passages are formed and a oxidant supplying plate (separator) on which oxidant passages are formed, are provided to form a single cell. A fuel cell system is fabricated by stacking a plurality of these single cells interspersed with cooling plates.

### EXAMPLES

The fuel cell of the present invention will be explained using the following examples, however the present invention is not limited thereto.

Preparation of Carbon Particles Loaded with Catalyst

(Platinum Loaded Carbon Particles for Cathode)

9 g of acetylene black and 200 g of water were mixed. An aqueous solution of hexachloroplatinic acid containing 1 g of platinum was further mixed to the resulting solution. The temperature of the solution was raised to 60° C. After confirming that the temperature was stable at 60° C., the pH value of the solution was adjusted to 10. Reduction of hexachloroplatinic was carried out by dripping 3% by weight of hydrazine solution. After the reduction, thus prepared carbon particles loaded with platinum was separated using a glass filter, then dried. The amount of platinum loaded on the carbon particles was 10% by weight.

(Platinum-Ruthenium Loaded Carbon Particles for Anode)

Platinum-ruthenium loaded carbon particles were obtained in the same manner as described above except that a solution of hexachloroplatinic acid containing 1.2 g of platinum and a solution of ruthenium chloride containing 1 g of ruthenium were mixed to the carbon-water mixed solution. The amount of loaded platinum was 10% by weight.

(Sulfonated Carbon Particles Loaded with Platinum for Cathode)

Acetylene black was partially sulfonated by treating with sulfuric acid. Thus obtained sulfonated carbon particles were further loaded with platinum as in the same manner as described above. The amount of loaded platinum was 10% by weight.

(Sulfonated Carbon Particles Loaded with Platinum for Anode)

Sulfonated carbon particles loaded with platinum-ruthenium were obtained in the same manner as described above. The amount of loaded platinum was 10% by weight.

Preparation of Pastes for Electrodes

(Preparation of Anode Paste 1)

Carbon particles loaded with platinum-ruthenium catalyst, distilled water, dispersed solution of 60% by weight of Teflon®, as a water repellent agent, and 5% by weight of Nafion® solution (produced by Aldrich Co.) were mixed so that the content of Teflon® was 10% by weight based on the total weight of solid component in the mixture. The mixture was homogeneously dispersed using a ultrasonic mixer to form Anode Paste 1.

(Preparation of Anode Paste 2)

Anode paste 2 was prepared in the same manner as Anode Paste 1 except that the content of Teflon® was 5% by weight.

(Preparation of Anode Paste 3)

Anode Paste 3 was prepared in the same manner as Anode Paste 1 except that the content of Teflon® was 5% by weight and the ratio of non-sulfonated carbon particles to sulfonated carbon particles (on both of which catalyst was loaded) was 3:1.

(Preparation of Anode Paste 4)

Anode Paste 4 was prepared in the same manner as Anode Paste 3 except that the ratio of non-sulfonated carbon particles to sulfonated carbon particles (on both of which catalyst is loaded) was 1:3.

(Preparation of Anode Paste 5)

Anode Paste 5 was prepared in the same manner as Anode Paste 1 except that the ratio of non-sulfonated carbon particles to sulfonated carbon particles (on both of which catalyst is loaded) was 3:1.

(Preparation of Cathode Pastes 1, 2, 3, 4 and 5)

Cathode Pastes 1, 2, 3, 4 and 5 were prepared in the same manner as Anode Pastes 1, 2, 3, 4 and 5 except that platinum loaded carbon particles were used instead of platinum-ruthenium loaded carbon particles.

Preparation of Water Repellent Carbon Paper

A carbon paper having a porosity of 75% and a thickness of 0.40 mm was applied with 0.5 mg/cm² of Teflon® on the surface by immersing the carbon paper in a Teflon® dispersed solution (produced by Dupont•MitsuiFluorochemicals Co., Ltd.). Water repellent carbon paper (hereafter merely referred to as carbon paper) was thus obtained.

Preparation of Electrodes

### Example 1

Anode Paste 1 was uniformly applied on one surface of carbon paper so that the amount of platinum applied on the carbon paper was 0.3 mg/cm², followed by drying the carbon paper at 80° C. for 1 hour in a nitrogen atmosphere. Then, Anode Paste 2 was uniformly applied on the surface applied with Anode Paste 1 of the carbon paper so that the amount of newly applied platinum was 0.3 mg/cm², followed by drying the carbon paper at 130° C. for 2 hours in a nitrogen atmosphere, thus an anode was prepared.

In the same manner as above, a cathode was prepared by uniformly applying Cathode Paste 1 twice on one surface of carbon paper so that the amount of platinum in one application of Cathode Paste 1 was 0.3 mg/cm².

A Nafion® film (thickness: 50 μm, produced by DuPont Corp.) was sandwiched by the anode and the cathode prepared as described above, followed by being hot pressed at 140° C. to form a monolithic film containing the two electrodes and the electrolyte (the Nafion® film) of Example 1.

### Example 2

A monolithic film containing the two electrodes and the electrolyte of Example 2 was prepared in the same manner as example 1 except that the cathode was prepared by applying Cathode Paste 2 and Cathode Paste 1 in that order on one surface of carbon paper so that the amount of platinum in one application of each of Cathode Paste 2 and Cathode Paste 1 was 0.3 mg/cm².

### Example 3

A monolithic film containing the two electrodes and the electrolyte of Example 3 was prepared in the same manner as Example 1 except that the anode was prepared by applying Anode Paste 3 and Anode Paste 4 in that order on one surface of carbon paper so that the amount of platinum in one application of each of Anode Paste 3 and Anode Paste 4 was 0.3 mg/cm².

### Example 4

A monolithic film containing the two electrodes and the electrolyte of Example 4 was prepared in the same manner as Example 1 except that the cathode was prepared by applying Cathode Paste 4 and Cathode Paste 3 in that order on one surface of a carbon paper so that the amount of platinum in one application of each of Cathode Paste 4 and Cathode Paste 3 was 0.3 mg/cm², and that the anode used in Example 3 was used.

### Example 5

A monolithic film containing the two electrodes and the electrolyte of Example 5 was prepared in the same manner as Example 1 except that the anode was prepared by applying Anode Paste 5 and Anode Paste 4 in that order on one surface of a carbon paper so that the amount of platinum in one application of each of Anode Paste 5 and Anode Paste 4 was 0.3 mg/cm², and that the cathode was prepared by applying Cathode Paste 4 and Cathode Paste 5 in that order on one surface of a carbon paper so that the amount of platinum in one application of each of Cathode Paste 4 and Cathode Paste 5 was 0.3 mg/cm².

Comparative Sample

A monolithic film containing the two electrodes and the electrolyte of Comparative sample was prepared in the same manner as Example 1 except that the anode was prepared by applying Anode Paste 1 twice on one surface of a carbon paper so that the amount of platinum applied in one application is 0.3 mg/cm².

Evaluation and Results

Using the above described monolithic films of Examples 1 to 5 and Comparative Sample, single cells of a direct methanol fuel cell were fabricated. A current-voltage property of each single cell was determined by supplying 1 mol/l of methanol aqueous solution with a flow rate of 6 ml/minute to the anode and air with a flow rate of 1000 ml/minute to the cathode, at 25° C. under an ambient pressure.

The results were summarized in Table 1.

TABLE 1

| | Current (mA/cm²) | | |
|---|---|---|---|
| Voltage (V) | 0.3 | 0.5 | 0.8 |
| Example 1 | 430 | 210 | 70 |
| Example 2 | 530 | 290 | 94 |
| Example 3 | 365 | 160 | 50 |
| Example 4 | 450 | 240 | 85 |
| Example 5 | 600 | 320 | 110 |
| Comparative | 300 | 120 | 38 |
| Sample | | | |

As shown in Table 1, the direct methanol fuel cells of Examples 1 to 5 showed higher performances compared to the cell performance of the direct methanol fuel cell of Comparative Sample.

1. A fuel cell comprising:
(a) a solid polymer electrolyte film;
(b) an anode layer, one surface of which contacting one surface of the solid polymer electrolyte film, and fuel being supplied to the other surface of the anode layer; and
(c) a cathode layer, one surface of which contacting the other surface of the solid polymer electrolyte film and an oxidizing gas being supplied to the other surface of the cathode layer,
wherein at least one of the anode layer and the cathode layer contains a water repellent agent and an ionic conductor,
wherein:
(i) a concentration of the water repellent agent in the anode layer decreases from the surface to which the fuel is supplied to the surface contacting the electrolyte film, when the anode layer contains the water repellent agent; and
(ii) a concentration of the water repellent agent in the cathode layer decreases from the surface contacting the electrolyte to the surface to which the oxidizing gas is supplied, when the cathode layer contains the water repellent agent.

2. A fuel cell comprising:
(a) a solid polymer electrolyte film;
(b) an anode layer, one surface of which contacting one surface of the solid polymer electrolyte film, and fuel being supplied to the other surface of the anode layer; and
(c) a cathode layer, one surface of which contacting the other surface of the solid polymer electrolyte film and an oxidizing gas being supplied to the other surface of the cathode layer,
wherein at least one of the anode layer and the cathode layer contains carbon particles having a hydrophilic surface and carbon particles having a hydrophobic surface, each of the carbon particles being loaded with a precious metal catalyst,
wherein:
(i) a weight ratio of the carbon particles having the hydrophobic surface to the total weight of the carbon particles in the anode layer decreases from the surface to which fuel is supplied to the surface contacting the electrolyte film, when the anode layer contains the carbon particles having the hydrophilic surface and the carbon particles having the hydrophobic surface; and
(ii) a weight ratio of the carbon particles having the hydrophobic surface to the total weight of the carbon particles in the cathode layer decreases from the surface contacting the electrolyte film to the surface to which an oxidizing gas is supplied, when the cathode layer contains the carbon particles having the hydrophilic surface and the carbon particles having the hydrophobic surface.

3. A fuel cell comprising:
(a) a solid polymer electrolyte film;
(b) an anode layer, one surface of which contacting one surface of the solid polymer electrolyte film, and fuel being supplied to the other surface of the anode layer; and
(c) a cathode layer, one surface of which contacting the other surface of the solid polymer electrolyte film and an oxidizing gas being supplied to the other surface of the cathode layer,
wherein at least one of the anode layer and the cathode layer contains a water repellent agent, an ionic conductor, carbon particles having a hydrophilic surface and carbon particles having a hydrophobic surface, each of the carbon particles being loaded with a precious metal catalyst is loaded,
wherein:
(i) a concentration of the water repellent agent and a weight ratio of the carbon particles having the hydrophobic surface to the total weight of the carbon particles in the anode layer decrease from the surface to which the fuel is supplied to the surface contacting the electrolyte film when the anode layer contains the water repellent agent, the carbon particles having the hydrophilic surface and the carbon particles having the hydrophobic surface; and
(ii) a concentration of the water repellent agent and a weight ratio of the carbon particles having the hydrophobic surface to total carbon particles in the cathode layer decrease from the surface contacting the electrolyte film to the surface to which the oxidizing gas is supplied when the cathode layer contains the water repellent agent, the carbon particles having the hydrophilic surface and the carbon particles having the hydrophobic surface.

4. The fuel cell of claim 2, wherein the hydrophilic carbon particles are carboxylic carbon particles or sulfonated carbon particles.

5. The fuel cell of claim 3, wherein the hydrophilic carbon particles are carboxylic carbon particles or sulfonated carbon particles.

6. The fuel cell of claim 2, wherein the carbon particles are selected from the group consisting of activated carbon particles, carbon black particles, graphite particles and mixed particles thereof.

7. The fuel cell of claim 3, wherein the carbon particles are selected from the group consisting of activated carbon particles, carbon black particles, graphite particles and mixed particles thereof.

8. The fuel cell of claim 2, wherein the precious metal catalyst is a platinum catalyst or a platinum alloy catalyst.

9. The fuel cell of claim 3, wherein the precious metal catalyst is a platinum catalyst or a platinum alloy catalyst.

10. The fuel cell of claim 1, wherein the fuel cell is a direct methanol fuel cell.

11. The fuel cell of claim 2, wherein the fuel cell is a direct methanol fuel cell.

12. The fuel cell of claim 3, wherein the fuel cell is a direct methanol fuel cell.
